(19) United States
(12) Patent Application Publication
(10) Pub. No.: US 2020/0074133 A1
(43) Pub. Date: Mar. 5, 2020

(54) PORTABLE DEVICE WITH FINGERPRINT PATTERN RECOGNITION MODULE

(71) Applicant: Zeppelin Corporation, Apia (WS)

(72) Inventors: Yi-Chuan CHENG, Changhua County (TW); Kuo-Ching CHIANG, New Taipei City (TW)

(21) Appl. No.: 16/122,453

(22) Filed: Sep. 5, 2018

(51) Int. Cl. G06K 9/00; G06K 9/40; G06F 3/044; G06Q 20/40

(52) U.S. Cl. CPC G06K 9/0002; G06K 9/0008; G06K 9/40; G06F 3/044; G06F 3/04883; G06Q 20/40145; G06K 9/00087; G06F 2203/04104; G06K 9/00026

(57) ABSTRACT

The present invention provides an electronic device providing with a security mode and an operation mode, wherein the electronic device includes a touch panel and a fingerprint pattern recognition module to obtain a fingerprint pattern of a finger of a user. The fingerprint pattern recognition module includes an ultrasound transceiver. A sample fingerprint is fetched by using the ultrasound transceiver of the fingerprint pattern recognition module.

### TECHNICAL FIELD

The present invention relates to a portable device, particularly to an electronic device with a fingerprint pattern recognition module.

### BACKGROUND OF RELATED ARTS

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone.

A fingerprint sensor is an electronic device used to capture a digital image of the fingerprint pattern. Optical fingerprint imaging involves capturing a digital image of the print using visible light. This type of sensor is, in essence, a specialized digital camera. The top layer of the sensor, where the finger is placed, is known as the touch surface. Ultrasonic sensors make use of the principles of medical ultrasonography in order to create visual images of the fingerprint. The device requires large arrays for touch input and currently, a fingerprint security device is also provided adjacent to the touch panel, typically, the fingerprint security device is formed of CMOS sensor which is made by the semiconductor method.

In an interactive flat panel display system typically includes an active matrix display panel and an interactive screen. The interactive screen includes a matrix of capacitors that are arranged at specific locations within the screen. The interactive screen is placed over the active matrix display panel such that the capacitors are arranged at strategic locations over the active matrix display panel.

### SUMMARY

The object of the present invention is to omit the additional CMOS fingerprint sensor.

The present invention provides a portable device comprising: a control unit; a display coupled to the control unit; a dual wireless module coupled to the control unit for wireless data transferring, wherein the dual wireless module includes a first and a second wireless data transferring modules to allow a user to select desired one to communicate with an external device.

A security method for an electronic device includes providing the electronic device with a security mode and an operation mode, wherein the electronic device includes a touch panel having a sensing array. A sample fingerprint is fetched by using the sensing array; a detected fingerprint is fetched by sensing a fingerprint using the sensing array in the security mode. The sample fingerprint is compared with the detected fingerprint in the security mode, followed by unlocking the electronic device if the detected fingerprint matches with the sample fingerprint, and switch the electronic device into the operation mode. A control signal is generated in responsive to a touching event, followed by controlling a virtual object displayed on a display in responsive to the control signal. The sensing array includes a capacitance sensing array. The sample fingerprint includes a sample capacitance pattern; the detected fingerprint includes a detected capacitance pattern. The electronic device includes a gesture application; the gesture application is disable in the security mode. The gesture application is enabled in the operation mode. A mobile communicating device includes a first conductive line on a substrate, an organic light emitting layer is formed over the first conductive line, a second conductive line is formed over the organic light emitting layer, a fingerprint X sensing line and a fingerprint Y sensing line are formed over the second conductive line, an isolation layer is formed over the fingerprint Y sensing line for isolating the fingerprint X sensing line and the fingerprint Y sensing line; and a connection is formed on the isolation for connecting the fingerprint X sensing line to another fingerprint X sensing line. The fingerprint X sensing line and the fingerprint Y sensing line are formed at the back side, front side, left or right side of the mobile communicating device. The fingerprint X sensing line and the fingerprint Y sensing line includes indium-tin oxide (ITO), carbon nanotubes (CNTs), graphene, conductive polymer or the combination thereof.

The present invention provides a portable device comprising: a control unit; a display coupled to the control unit; an ultrasonic transmitter under the display to detect a fingerprint pattern; an ultrasonic receiver under said display to receive a detected echo from the fingerprint pattern, wherein a spacing between ridges and valleys of the fingerprint is larger than an ultrasound wave length generated by the ultrasonic transmitter; and a reflecting echoes processing module responsive to the detected echo to generate a fingerprint data.

The reflecting echoes processing module performs image processing of ultrasonic data of the detected echo by performing at least one of demodulation and decimation, thereby generating a plurality of image data. The ultrasonic transmitter is an ultrasound MEMS (Micro Electro Mechanical System) device.

The portable device further comprises a virtual payment tool stored in the mobile communicating device to perform a transaction, wherein the transaction is verified by the fingerprint pattern. The ultrasound transceiver includes an ultrasonic transmitter and an ultrasonic receiver. A spacing between pixels of a touch panel of the display is smaller than an ultrasound wave length generated by the ultrasonic transmitter, thereby omitting an effect caused by a grating configured by an array of pixels. The portable device further comprises a background filter to filter out a background echo to obtain the detected echo of the fingerprint. In another embodiment, a background filter is coupled to the ultrasonic transmitter to recover fingerprint's image data of the user. An ultrasound MEMS (Micro Electro Mechanical System) transmitter is formed under the display to detect a fingerprint pattern of a user.

### BRIEF DESCRIPTION OF THE DRAWING

FIG. 1 shows a diagram of a portable device according to the present invention.

FIG. 2 shows a flow chart according to the present invention.

FIG. 3 shows a cross sectional view according to the present invention.

FIG. 4 shows a diagram of a portable device according to another embodiment of the present invention.

FIG. 5 shows a diagram of a fingerprint pattern recognition module according to one embodiment of the present invention.

FIG. 6 shows a diagram of a portable device according to another embodiment of the present invention.

FIG. 7 shows a diagram of a portable device with a ultrasound transceiver according to another embodiment of the present invention.

### DETAILED DESCRIPTION

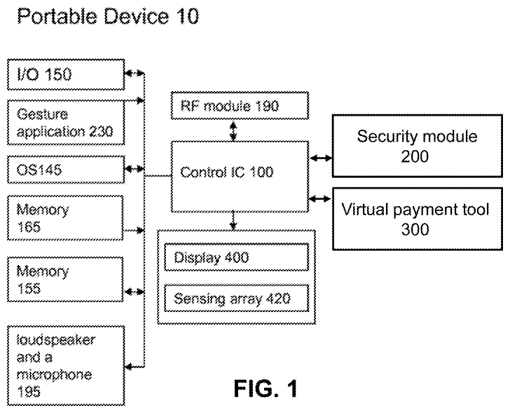

The present invention relates generally to a computing or portable device. The device includes but not limited to mobile communicating device, cellular phone, PDA (personal digital assistant), smart phone, notebook, digital still camera, digital video camera, medium player (MP3, MP4), GPS, tablet and the equivalent thereof. FIG. 1 is a diagram illustrating main components of a portable communication device having a touch panel according to an embodiment of the present invention. The embodiment, as shown in FIG. 1, the device 10 includes a RF module 190. As known in the art, the RF module 190 includes antenna. This antenna is connected to a transceiver, which is used to receive and transmit signal. AS known, the RF module 190 further includes CODEC, DSP and A/D converter as well. Due to the RF module is not the feature of the present invention, therefore, the detailed description is omitted. The present invention includes a central control IC 100, an input and output (I/O) unit 150, OS 145, a memory 165, the device 10 may include other memory 155 such as ROM, RAM and FLASH memory. The RF module may perform the function of signal transmitting and receiving, frequency synthesizing, base-band processing and digital signal processing. If the portable device is cellular, SIM card hardware interface is provided for receiving a SIM card. Finally, the signal is sent to the final actuators, i.e. a loudspeaker and a microphone 195 or I/O 150.

The present invention further includes a wireless transmission/receiving module (not shown) coupled to the control IC 100. The transmission/receiving module is compatible with blue-tooth, home-RF, 802.11x, WiFi, WiMAX standard or their higher version. The transmission domain (the air) by nature is not secured and therefore encryption maybe essential in the wireless transport networks. In one embodiment, pair-wise encryption/decryption between every neighboring wireless network device of a wireless transport network is well-known in the art. A data frame that leaves from one wireless device from one end of a wireless transport network to the other end of the same network might need several encryptions and decryptions before it reaches its final destination. An operating system which runs on CPU, provides control and is used to coordinate the function of the various components of system and Application programs. A program is set up in the device to use the electrical signals to control functions and/or functions controlled by the device.

The portable electronic device is, for example cellular phones, PDAs, media players, and GPS, or notebook, Tablet PCs and game players. The portable electronic device is configured with a sensor array on the display. The sensor array is configured to detect the presence of an object such as a finger as well as the location being exerted on the surface of the panel by the finger or palm of the hand. By way of example, the sensor array may be based on capacitive sensing. Typically, the sensing array includes an x-electrode array and y-electrode array to sense the x axis and y axis touching evens to determines the touching position.

The portable electronic device includes a housing and a display 400 situated in a front surface of the housing. The portable electronic device also includes a touch sensing array 420 situated on the display 400. The touch panel includes the display 400 and the touch sensing array 420. The touch sensing array 420 may be a finger detecting array formed over the display 400, wherein the finger detecting array includes at least one electrode and the finger detecting array is employed to fetch capacitance of a user finger, thereby generating a security pattern. In one embodiment, the display is a rollable display or a bendable display. In general, the touch sensing array 420 includes a first electrode array and a second electrode array to sense a first direction and a second direction touching evens to determine the touching position. Material of the electrode array can be selected from carbon nanotubes (CNTs), or graphene. Carbon nanotubes (CNTs) are allotropes of carbon with a cylindrical nanostructure. In particular, owing to their extraordinary thermal conductivity and mechanical and electrical properties, carbon nanotubes find applications as additives to various structural materials. On the other hand, there was evidence that in the radial direction they are rather soft. Radial direction elasticity of CNTs is important especially for carbon nanotube composites where the embedded tubes are subjected to large deformation in the transverse direction under the applied load on the composite structure. Graphene has many extraordinary properties. It is about 100 times stronger than the strongest steel. It conducts heat and electricity efficiently and is nearly transparent. Carbon nanotubes are one of the strongest materials in nature. Carbon nanotubes are long hollow cylinders of graphene. Although graphene sheets have 2D symmetry, carbon nanotubes by geometry have different properties in axial and radial directions. It has been shown that CNTs are very strong in the axial direction. Young's modulus on the order of 270-950 GPa and tensile strength of 11-63 GPa were obtained. FIG. 1 is a perspective diagram of a hand held electronic device in accordance with one embodiment of the present invention. The hand held electronic device includes a housing that encloses internally various electrical components including integrated circuit chips. The hand held electronic device also includes a display disposed within and viewable through an opening in the housing. The display provides visual information in the form of text, characters or graphics. In order to generate user inputs, the hand held electronic device may include a sensing array that is a transparent input panel positioned in front of the display. The sensing array generates input signals when an object such as a finger is moved across the surface of the sensing array, for example linearly, radially, rotary, etc., from an object holding a particular position on the array and/or by a finger tapping on the array. In most cases, the sensing array allows a user to initiate movements in a GUI by simply touching the display screen via a finger. For example, the sensing array recognizes the touch and position of the touch on the display and an interpreting controller of the hand held electronic device interprets the touch and thereafter performs an action based on the touch event. In accordance with one embodiment, the sensing array is a multi-touch sensing device that has the ability to sense multiple points of contact at the same time and report the multiple touches to the controller of the handheld electronic device. In one implementation, the sensing array is a multipoint capacitive touch screen that is divided into several independent regions. The sensing points, which are typically transparent, are dispersed about the sensing array with each sensing point representing a different position on the surface of the display. The sensing points may be positioned in a grid or a pixel array where each pixilated sensing point is capable of generating a signal. The signal is produced each time an object is positioned over a sensing point. When an object is placed over multiple sensing points, multiple signals can be generated. The sensing points generally map the touch screen plane into a coordinate system such as a Cartesian coordinate system or a Polar coordinate system.

The hand held electronic device may be designed to recognize gestures applied to the sensing array 420 which is coupled to the control unit and to control aspects of the hand held electronic device based on the gestures. In one embodiment, the sensing array 420 is configured on a front side of the hand held electronic device for sensing the touch event of a front side surface of the hand held electronic device. In one embodiment, the sensing array 420 is configured on a back side of the hand held electronic device for sensing the touch event of a back side surface of the hand held electronic device. The gestures may be made through various particularly finger motions. The hand held electronic device may include a gesture operational program (application) 230, which may be part of the operating system or a separate application. The gestural operation program 230 generally includes a set of instructions that recognizes the occurrence of gestures and informs one or more software agents of the gestures and/or what action(s) to take in response to the gestures.

In one embodiment, the sensing input device is mapped to the display. When mapped, points on the sensing input device coincide with points on the display, i.e., have the same coordinates (x and y). Therefore, when a user touches the sensing input device surface, it will appear as if the user is touching the image at the same location of the display. As shown, the sensing array is divided into several independent and spatially distinct sensing points (or regions) that are positioned within the respective component. The sensing points are generally dispersed about the respective component with each sensing point representing a different position on the surface of the component. The number and configuration of sensing points generally depends on the desired resolution of the touch sensitive surface. In the case, a signal is produced each time the finger is positioned over a sensing point. As should be appreciated, the number, combination and frequency of signals in a given time frame may indicate size, location, direction, speed, acceleration and the pressure of the finger or palm on the surface of the device. By way of example, the control system may be a microcontroller located within the housing of the device.

The signals generated at the sensing points may be used to determine how the user would like to move the web page or virtual object displayed on the display. By way of example, each portion of the hand in contact with the device produces a contact patch area. Each of the contact patch areas covers several sensing points thus generating several signals. The signals may be grouped together to form a signal that represents how the user is moving the virtual object or page. In one embodiment, the difference between a current signal and a last hand signal may indicate the user's desire to implement a function of moving web-page. Changes between contact patch areas may further indicate the particular moving signal. The touch surface is divided into one or more button zones that represent regions of the device that when selected implement the particular button function associated with the button zone. The position and size of the button zones may also be customizable. For example, page back, page next and so on. The customization may be performed by the user and/or the device.

The finger has fingerprints, and the fingerprints are the traces of an impression from the friction ridges of any part of a human or other primate hand. Fingerprints are one of many forms of biometrics used to identify individuals and verify their identity. A friction ridge is a raised portion of the epidermis on the digits. These are sometimes known as “epidermal ridges. When, the finger locates on the capacitor sensor, for example, on the touch panel. The fingerprint will cause different capacitance in different points due to the pattern of the fingerprint. Capacitance sensors use principles associated with capacitance in order to form fingerprint images. In this method of imaging, the sensor array pixels each act as one plate of a parallel-plate capacitor, the dermal layer (which is electrically conductive) acts as the other plate, and the non-conductive epidermal layer acts as a dielectric. In one example, one plate of a parallel-plate capacitor includes the material which is selected from carbon nanotubes (CNTs), graphene, conductive polymer or the combination thereof. As mentioned, carbon nanotubes (CNTs) are subjected to large deformation in the transverse direction under the applied load on the composite structure. Graphene is about 100 times stronger than the strongest steel. They both are electricity efficiently and nearly transparent. A passive capacitance sensor uses the principle outlined above to form an image of the fingerprint patterns on the dermal layer of skin. Each sensor pixel is used to measure the capacitance at that point of the array. The capacitance varies between the ridges and valleys of the fingerprint due to the fact that the volume between the dermal layer and sensing element in valleys contains an air gap. The dielectric constant of the epidermis and the area of the sensing element are known values. The measured capacitance values are then used to distinguish between fingerprint ridges and valleys. When in the mode of recognition or sample (template) fetching mode, the gesture application is off (disable), the security module 200 records the capacitance pattern caused by the fingerprint. Therefore, the sample of the fingerprint is fetched. Each of the contact patch areas covers several sensing points thus generating several signals. The signals may be grouped together to form a signal that represents the fingerprint pattern. The electronic device is provided with a control unit and a touch panel having a sensing array which is coupled to the control unit, wherein the electronic device includes a security mode and an operation mode coupled to the control unit.

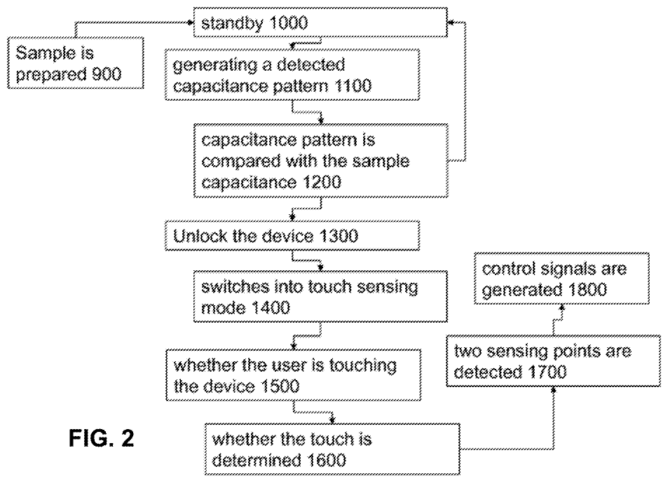

FIG. 2 is an operational method in accordance with one embodiment of the present invention. In step 900, the finger print sample or template is prepared by sensing the finger capacitance pattern by disable the gesture application. The method generally begins at block 1000 where the device is in standby. The device is in security mode, no one can operate the device without the fingerprint. In the security mode, the gesture application is not-activated or disable (off), the security module 200 fetched the capacitance of each points of the finger, thereby generating a detected capacitance pattern in block 1100. The capacitance pattern is compared with the sample capacitance to determine whether lock or unlock the device in 1200. If it is matched, the device is unlocked 1300. After unlock the device such as cellular, it switches into an operational mode or touch sensing mode, and it standbys for signal input 1400, and the gesture application is enabled or activated, standby generally implies that the device is in a state of readiness waiting for something to happen, i.e., a user initiating an action therewith. Following block 1400, the process flow proceeds to block 1500 where a determination is made as to whether the user is touching the device. This is generally accomplished with touch sensing device capable of generating signals when a hand nears the device and a control system configured to monitor the activity of the touch sensing device. If it is determined that the user is not touching the device, then the process flow proceeds back to block 1400 thereby keeping the device in standby. If it is determined that the user is touching the device, then the process flow proceeds to block 1600 where the touched is determined. A virtual payment tool 300 is stored in the mobile phone for transaction, wherein the transaction is verified by the security pattern generated from user finger capacitance. The virtual payment tool 300 is coupled to the control IC 100.

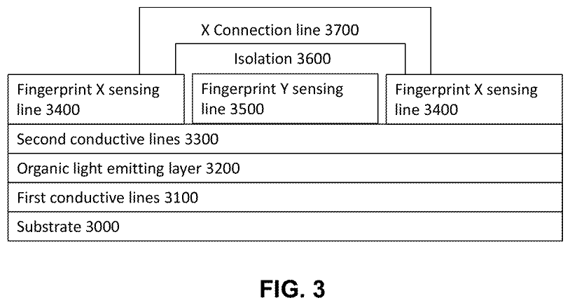

In one embodiment, once the second location is determined, the process flow proceeds to block 1700, at least two sensing points signals are detected by the controller. Following block 1700 the process flow proceeds to block 1800, where touch events are monitored, control signals are generated based on the touch event. The control signals may be used to inform the application software within the device to move the virtual object or page displayed on the screen instead of by moving the page by keys, cursor or touch pen. In one example, please refer to FIG. 3, the security device includes fingerprint X direction sensing lines 3400 and fingerprint Y direction sensing lines 3500 formed on a same layer. An isolation layer 3600 is formed on the fingerprint X direction sensing lines 3500 for isolating the fingerprint X direction sensing lines 3400 and fingerprint Y direction sensing lines 3500. A connection layer 3700 is formed on the isolation layer 3600 for connecting the fingerprint X direction sensing lines 3500. In one case, the fingerprint X direction sensing lines 3400 and fingerprint Y direction sensing lines 3500 are formed of ITO, carbon nanotubes (CNTs), graphene, conductive polymer or the combination thereof. In one example, the fingerprint X direction sensing lines 3400 and fingerprint Y direction sensing lines 3500 are formed over the second conductive lines 3300 which is formed over an organic light emitting layer 3200. The organic light emitting layer 3200 is formed over the first conductive lines 3100 over a substrate 3000. The second conductive lines 3300 and the first conductive lines 3100 are formed of ITO, carbon nanotubes (CNTs), graphene, conductive polymer or the combination thereof. A passive capacitance sensor uses the principle outlined above to form an image of the fingerprint patterns. The capacitance varies between the ridges and valleys of the fingerprint. The measured capacitance values are then used to distinguish between fingerprint ridges and valleys.

The processor can be implemented on a single-chip, multiple chips or multiple electrical components. For example, various architectures can be used for the processor, including dedicated or embedded processor, single purpose processor, controller, ASIC, and so forth. In most cases, the processor together with an operating system operates to execute computer code and produce and use data. The operating system may correspond to well-known operating systems such as OS/2, DOS, Unix, Linux, and Palm OS. Memory provides a place to store computer code, the memory may include Read-Only Memory (ROM), Random-Access Memory (RAM), hard disk drive, flash memory and/or the like. The display is generally configured to display a graphical user interface (GUI) that provides an easy to use interface between a user of the electronic device and the operating system or application running thereon. The electronic device also includes a touch screen that is operatively coupled to the processor. The touch screen is configured to transfer data from the outside into the device. The electronic device also includes a sensing device that is operatively coupled to the processor. The sensing device may also be used to issue web page moving commands.

Examples of hand held devices include PDAs, Cellular Phones, Media player, Game players, Cameras, GPS receivers and the like. Therefore, the user may move the web page, image or document displayed on the page by directly moving the finger on the sensing array. The user may move the web-page, text, image, icon shown on the display directly by hand or user finger.

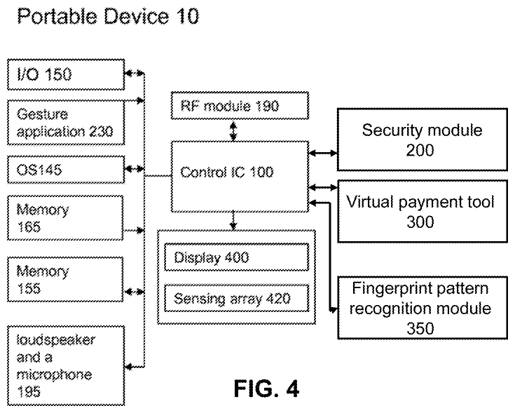

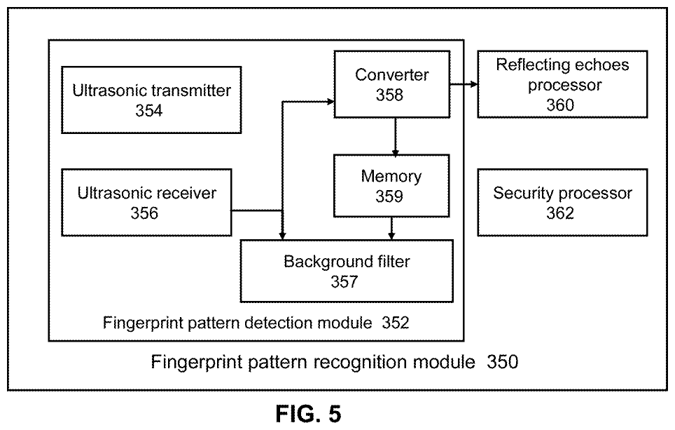

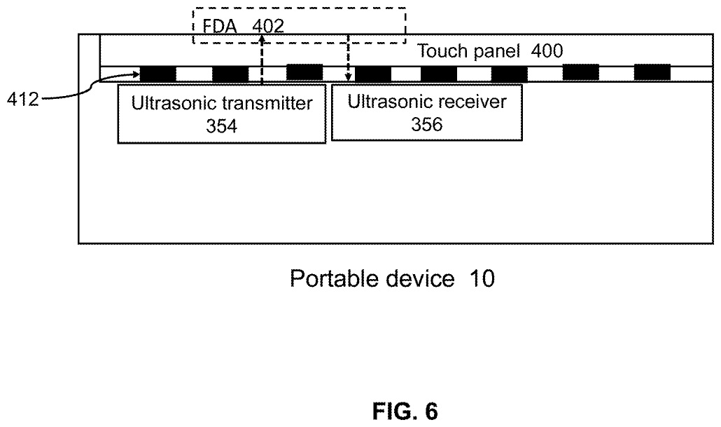

FIG. 4 shows a diagram of a portable device according to another embodiment of the present invention. The main components of the portable device 10 having a display 400 with touch panel is illustrated in FIG. 4. In this embodiment, the portable device 10 further includes a fingerprint pattern recognition module 350 used to authenticate a user's identity via fingerprint of a user. As shown in FIG. 5, the fingerprint pattern recognition module 350 includes a fingerprint pattern detection module 352 to obtain image data of fingerprint pattern when a finger of a user presses a detection area on the touch panel 370 of the portable device 10. The fingerprint pattern detection module 352 includes an ultrasonic transmitter 354, an ultrasonic receiver (ultrasound sensor) 356 and a converter 358. The ultrasonic transmitter 354 is configured to generate ultrasound wave to detect a user's finger print. A spacing varies between the ridges and valleys of the fingerprint, and the spacing is larger than wave length of the ultrasound wave generated by the ultrasonic transmitter 354. The ultrasonic transmitter 354 operates with frequencies from 20 kHz up to several gigahertz. The ultrasonic receiver (ultrasound sensor) 356 is used sense ultrasonic echo signals of the ultrasound wave reflected by the finger of the user. The converter 358 is adapted to convert ultrasonic echo signals received by the ultrasonic receiver 356 into digital signals. The converter 358 converts the analog ultrasonic data into a digital data. For example, the converter 358 may include an analog to digital converter (ADC). The ultrasonic transmitter 354 and the ultrasonic receiver 356 are placed under the display 400, as shown in FIG. 6. In one embodiment, the fingerprint pattern recognition module 350 also includes a reflecting echoes processor or processing module (image processor) 360 to process the image data to generate a scanned (reflected) fingerprint pattern and compare the scanned (reflected) fingerprint pattern to a pre-stored pattern stored on the portable device 10 to authenticate the image data, and a security processor 362 to generate a transaction code to authorize a transaction upon authentication of the image data. The reflecting echoes processor 360 can obtain image data by image-processing the digital ultrasonic data. In detail, the reflecting echoes processor 130 may perform the image processing of the ultrasonic data by performing at least one of demodulation and decimation, thereby generating the plurality of image data. In digital signal processing, decimation is the process of reducing the sampling rate of a signal. The reflecting echoes processor 360 and the security processor 362 may be integrated to be a specified digital processor. In one embodiment, the fingerprint pattern recognition module 350 may include a digital computing element including a digital processor and a memory for storing instructions and data, and the digital computing element is configured to be operatively coupled with the ultrasonic receiver 356 (converter 358) to calculate user's finger print. The ultrasonic transmitter 354 may be an ultrasound MEMS (Micro Electro Mechanical System) device which includes a piezoelectric thin film device (piezoelectric crystal) for creating ultrasound wave. The piezoelectric thin film device is driven by a current created by a transducer of the ultrasound MEMS device.

As shown in FIG. 6, the ultrasonic transmitter 354 and the ultrasonic receiver 356 are arranged under the fingerprint detecting area (FDA) 402 of the display 400. The ultrasound wave emitted from the ultrasonic transmitter 354 is transmitted to a target object's surface and then reflected off the target object's surface, followed by receiving by the ultrasonic receiver 356. The converter 358 is used to convert ultrasonic echo signals into digital signals. For example, the ultrasonic transmitter 354 and the ultrasonic receiver 356 are placed under the display 400. For example, the ultrasonic transmitter 354 may generate a plurality of different ultrasound wavelengths. The display 400 with touch panel includes an array of pixels 412. Each pixel 412 includes three sub-pixels. In some embodiments, each sub-pixel may correspond to a particular color, such as red, green, or blue. Pixels 412 and sub-pixels may be arranged in a repeating pattern along a horizontal axis and a vertical axis that are substantially perpendicular to each other. Sub-pixel may have a substantially rectangular shape, square, round, oval, or chevron-shaped. Each pixel 412 has a horizontal pixel pitch, which may be defined as the distance between corresponding features of two adjacent pixels along horizontal axis. Each pixel 412 also has a vertical pixel pitch, which may be defined as the distance between corresponding features of two adjacent pixels along vertical axis. In some embodiments, the horizontal pixel pitch may be approximately 50 μm (micrometer), 100 μm, 150 μm, 200 μm, 250 μm, 300 μm, or any suitable dimension. In some embodiments, the vertical pixel pitch may be approximately 50 μm (micrometer), 100 μm, 150 μm, 200 μm, 250 μm, 300 μm, or any suitable dimension. The horizontal pixel pitch or the vertical pixel pitch of the pixels 412 is smaller than wave length of the ultrasonic signal generated by the ultrasonic transmitter 354. For a 40 kHz ultrasonic signal generated by the ultrasonic transmitter 354 at temperature 25C, a half wavelength is equal to 4.25 mm (micrometer). Frequency of the ultrasonic signal may be selected such that interference or diffraction would not happen when the ultrasonic signal encounters to the display 400 with touch panel. That is, the ultrasonic signal generated by the ultrasonic transmitter 354 propagating to the display 400 only generates two interaction behaviors, reflection and transmission. In non-touching mode, a finger of a user does not contact to or touch on the transparent substrate of the display panel 400, the fingerprint pattern recognition module 350 is activated and ultrasonic signal is emitted from the ultrasonic transmitter 354 to generate ultrasonic signal which is reflected off the touch panel 400 and sensed or recorded by the ultrasonic receiver 356 to form a background ultrasonic signal. The background ultrasonic signal is converted by the converter 358 to form a first digital data which may be stored in a memory 359. In touching mode, when a finger of a user is placed on the transparent substrate encapsulating the display panel 400, the fingerprint pattern recognition module 350 is then activated and the ultrasonic transmitter 354 may generate the detecting ultrasonic wave, the detected reflecting echo signal is the superposition wave of the background signal and the fingerprint's echo signals reflected off the user's finger, transmitted and sensed or recorded by the ultrasonic receiver 356. The detected reflecting echo signal is converted by the converter 358 to form a second digital data which may be stored in the memory 359. The second digital data is filtering out the first digital data by a background filter 357 to recover the fingerprint's image data. The background filter 357 is used to filter out a background echo to obtain the detected echo of the fingerprint. The background filter 357 is coupled to the ultrasonic receiver 356 to recover fingerprint's image data. The reflecting echoes processor 360 processes the fingerprint's image data obtained by the ultrasonic receiver 356 of the fingerprint pattern detection module 352 to generate a scanned fingerprint pattern. In one example, the reflecting echoes processor 360 may use a similar stitching algorithm for scanning fingerprint pattern.

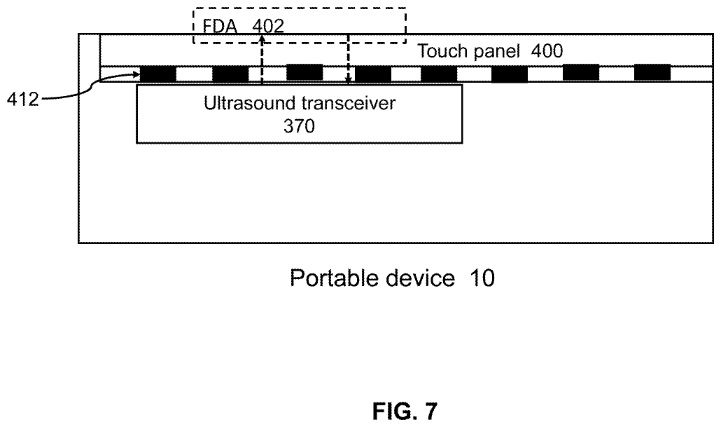

Please refer to FIG. 7, the fingerprint pattern recognition module 350 includes an ultrasound transceiver 370 which may include an ultrasonic transmitter and an ultrasonic receiver. Ultrasonic transmitter and ultrasonic receiver may be implemented as a single ultrasonic transceiver. The ultrasound transceiver 370 is adapted to receive ultrasonic echo signals reflected after transmitting unfocused or defocused ultrasonic signals having a frame rate. The ultrasound transceiver 370 generates unfocused or defocused ultrasonic signals, and transmits the generated ultrasonic signals to the touch panel 400. For example, the unfocused ultrasonic signal may be a plane wave, and the defocused ultrasonic signal may be a fan-shaped spherical wave. The ultrasound transceiver 370 obtains ultrasonic data by receiving echo signals reflected by the display 400, in an analog form. The reflecting echoes processor (image processor) 360 is adapted to generate a plurality of image data by processing the digital signals. The reflecting echoes processor 360 processes the fingerprint's image data obtained by the ultrasound transceiver 370 of the fingerprint pattern detection module 352 to generate a scanned fingerprint pattern. As noted above, the reflecting echoes processor 360 may use a similar stitching algorithm for scanning fingerprint pattern. If image data having different sizes are generated due to receiving echo signals that are the reflected in response to transmitting the defocused ultrasonic signals, the reflecting echoes processor 360 may edit the fingerprint's image data having different sizes into image data of a predetermined size. The advantages of the portable device 10 of the present invention including the fingerprint pattern recognition module 350 includes the ultrasound transceiver capable of ultrasound sensing into the dermal layer of the fingerprint on the touch panel, due to the dermal layer underneath the epidermal layer not easily worn and stained, and the extracted fingerprint is more clearer and complete than that obtained by optical sensing, and without the interactive screen which includes a matrix of capacitors that are arranged at specific locations within the screen.

In accordance with the present invention, a fingerprint pattern recognition module 350 may be used as part of a security feature for initiating a transaction, unlocking the device, accessing control or accessing a remote server. In a further embodiment, data from the fingerprint pattern recognition module 350 may be used as part of an encryption technique. The security processor 362 generates a transaction or authentication code to authorize a transaction upon authentication of the image data of fingerprint pattern, where the transaction code is transmitted through a contact method with a card reader or contactlessly via Near-field communication (NFC).

In one embodiment, the portable device 10 includes a fingerprint pattern recognition module 350, and the customer presses the transparent substrate of the display panel 400 to verify the user's identity. Fingerprint data may also be used to encrypt account information. In one embodiment, when the customer presses a finger to the transparent substrate of the display panel 400, the portable device's short range wireless transceiver will send a transaction signal to the vending machine. This also authorizes the vending machine to copy your account file from cell phone. This method will prevent someone close by from intercepting the short range transceiver file data during transmission to the vending machine.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

I claim:

1. A mobile communicating device, comprising:
a control unit;
a display coupled to said control unit;
an ultrasonic transmitter under said display to detect a fingerprint pattern;
an ultrasonic receiver under said display to receive a detected echo from said fingerprint pattern, wherein a spacing between ridges and valleys of said fingerprint is larger than an ultrasound wave length generated by said ultrasonic transmitter; and
a reflecting echoes processing module responsive to said detected echo to generate a fingerprint data.

2. The mobile communicating device of claim 1, wherein said mobile communicating device includes a security mode and an operation mode coupled to a control unit.

3. The mobile communicating device of claim 1, further comprising a virtual payment tool stored in said mobile communicating device to perform a transaction, wherein said transaction is verified by said fingerprint pattern.

4. The mobile communicating device of claim 1, wherein said reflecting echoes processing module performs image processing of ultrasonic data of said detected echo by performing at least one of demodulation and decimation, thereby generating a plurality of image data.

5. The mobile communicating device of claim 1, wherein said ultrasonic transmitter is an ultrasound MEMS (Micro Electro Mechanical System) device.

6. The mobile communicating device of claim 1, wherein a spacing between pixels of a touch panel of said display is smaller than said ultrasound wave length generated by said ultrasonic transmitter, thereby omitting an effect caused by a grating configured by an array of pixels.

7. The mobile communicating device of claim 1, further comprising a background filter to filter out a background echo to obtain said detected echo of said fingerprint.

8. A mobile communicating device, comprising:
a control unit;
a display coupled to said control unit;
an ultrasonic transmitter under said display to detect a fingerprint pattern of a user;
an ultrasonic receiver under said display to receive a detected echo from said fingerprint pattern, wherein a spacing between ridges and valleys of said fingerprint is larger than an ultrasound wave length generated by said ultrasonic transmitter; and
a reflecting echoes processing module responsive to said detected echo to generate a fingerprint data, wherein a spacing between pixels of a touch panel of said display is smaller than said ultrasound wave length generated by said ultrasonic transmitter.

9. The mobile communicating device of claim 8, further comprising a virtual payment tool stored in said mobile communicating device to perform a transaction, wherein said transaction is verified by said fingerprint pattern.

10. The mobile communicating device of claim 8, wherein said reflecting echoes processing module performs image processing of ultrasonic data of said detected echo by performing at least one of demodulation and decimation, thereby generating a plurality of image data.

11. The mobile communicating device of claim 8, wherein a spacing between ridges and valleys of said fingerprint of said user is larger than an ultrasound wave length generated by said ultrasonic transmitter.

12. The mobile communicating device of claim 8, wherein said ultrasonic transmitter is an ultrasound MEMS (Micro Electro Mechanical System) device.

13. The mobile communicating device of claim 8, further comprising a background filter coupled to said ultrasonic receiver to recover fingerprint's image data.

14. A mobile communicating device, comprising:
a control unit;
a display coupled to said control unit;
an ultrasound MEMS (Micro Electro Mechanical System) transmitter formed under said display to detect a fingerprint pattern of a user;
an ultrasonic receiver under said display to receive a detected echo from said fingerprint pattern; and
a reflecting echoes processing module responsive to said detected echo to generate a fingerprint data.

15. The mobile communicating device of claim 14, wherein said mobile communicating device includes a security module and an operation mode coupled to a control unit.

16. The mobile communicating device of claim 14, further comprising a virtual payment tool stored in said mobile communicating device to perform a transaction, wherein said transaction is verified by said fingerprint pattern.

17. The mobile communicating device of claim 14, further comprising a background filter coupled to said ultrasonic receiver to recover fingerprint's image data.

18. The mobile communicating device of claim 14, wherein a spacing between ridges and valleys of said fingerprint of said user is larger than an ultrasound wave length generated by said ultrasound MEMS (Micro Electro Mechanical System) transmitter.

19. The mobile communicating device of claim 14, wherein a spacing between pixels of a touch panel is smaller than an ultrasound wave length generated by said ultrasound MEMS (Micro Electro Mechanical System) transmitter.

20. The mobile communicating device of claim 14, wherein said mobile communicating device includes a gesture application, wherein said gesture application is disabled in a security mode, wherein said gesture application is enabled in a gesture mode.
